(19) United States
(12) Patent Application Publication
(10) Pub. No.: US 2022/0140778 A1
(43) Pub. Date: May 5, 2022

(54) SOLAR PANEL SYSTEM AND APPARATUS THEREOF

(71) Applicant: Shane T. Ellis, Gainesville, FL (US)

(72) Inventor: Shane T. Ellis, Gainesville, FL (US)

(21) Appl. No.: 17/089,470

(22) Filed: Nov. 4, 2020

(51) Int. Cl. H02S 30/20; H02S 40/32; H02S 40/38; H02S 30/10; H02S 20/10; H02S 40/34; H02S 50/00

(52) U.S. Cl. CPC H02S 30/20; H02S 40/32; H02S 40/38; H02S 50/00; H02S 20/10; H02S 40/34; H02S 30/10

(57) ABSTRACT

A detachable solar power apparatus and system is disclosed herein. In particular, the solar power system and apparatus enables homeowners/installers the ability to uninstall and remove the system from one property and to later re-install it at another property. The solar power system may include one or more solar panels coupled to a folding rectangular frame. The system may further include an inverter coupled to the one or more solar panels to convert DC power into AC power for an alternating current (AC) load. The inverter may include a management control module for detecting when power associated with the DC is above peak power for the AC load, wherein one or more chargeable batteries may be coupled thereto to absorb any excess power. The system may further include a power interface between the inverter, batteries, and the AC load associated with a house or an electric vehicle.

### CROSS REFERENCE TO RELATED APPLICATIONS

This present application relates to commonly-owned U.S. patent application Ser. No. 62/988,413, entitled “Renter Solar Unit,” naming Shane Ellis as the inventor, filed Mar. 12, 2020, which is currently co-pending application of which the present application is entitled to the benefit of the filing date; the contents of which are incorporated by herein by reference in its entirety.

### BACKGROUND

In the advent of global warming, solar panel systems provide a green source of energy, third in place after wind and hydro energy systems. Particularly, solar panel systems employ the use of solar cells, which convert the light of the sun into electricity using semiconducting materials that exhibit the photovoltaic effect (wherein the material absorbs sunlight, which causes excitation of an electron or other charge carrier to a higher energy state). Specifically, a flow of electrons may be generated using sunlight to supply power to equipment, appliances, lighting, batteries, and even vehicles.

However, many of the current solar panel systems installed in residential areas are fixed and immovable. That is, they are not readily available to be moved when a homeowner or tenant moves to another residence. Further, these systems must be mounted to the roof, leading to roof leaks, installation safety issues, and lack of curb appeal.

Although portable solar power devices are available, many of these are substantially limited in power and are not reliable sources of energy. Specifically, most of these types of power supply cannot provide the amount of power necessary for a common household's power capacity. Further, they cannot be connected to the power grid or easily switched in lieu of the electricity supplied by a power utility company.

It is within this context that the embodiments arise.

### SUMMARY

Embodiments of a solar power apparatus and system for providing solar power to a house and a car is provided. It should be appreciated that the present embodiment can be implemented in numerous ways, such as a process, an apparatus, a system, a device, or a method. Several inventive embodiments are described below.

In some embodiments, a solar power system is provided. In particular, the detachable solar power system may enable homeowners the ability to uninstall and remove the system from a property and to later re-install it at another property. The solar power system may include one or more solar panels coupled to a folding rectangular frame. The system may further include an inverter coupled to the one or more solar panels to convert Direct Current (DC) power into AC power for an alternating current (AC) load. The inverter may include a management control module for detecting when power associated with the DC is above peak power for the AC load. One or more chargeable batteries may couple to the inverter for absorbing the excess power supplied by the solar panels. The system may further include a power interface between the inverter, the one or more batteries, and the AC load associated with a house or an electric vehicle.

In some embodiments, a solar power apparatus is provided. The solar power apparatus may include one or more solar panels coupled to a folding rectangular frame. The folding rectangular frame may include a first and a second triangular frame portion coupled together. The folding rectangular frame may include a pair of hind legs coupled to the second triangular frame. For additional support, a pair of stabilizing bars may be coupled to the first triangular frame and the second triangular frame. A plurality of solar rails may be coupled to the first triangular frame and the second triangular frame for connecting the one or more solar panels to the folding rectangular frame. The apparatus may further include an inverter coupled to the one or more solar panels to convert the DC power supplied by the solar panels into AC power for the AC load. The inverter may include a management control module for detecting when power associated with the DC is above peak power for the AC load. One or more chargeable batteries may couple to the inverter for absorbing the excess power supplied by the solar panels. In operation, when the power supplied by the solar panels is above peak power, the inverter will redirect the power supplied form the solar panels to charge the chargeable batteries.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one so skilled in the art without departing from the spirit and scope of the described embodiments.

FIG. 1 is a perspective view of a solar power system, in accordance with some embodiments.

FIG. 2 is a block diagram of the solar power system of FIG. 1 as installed at a house to provide power for various AC loads, such as lights, household appliances, and one or more vehicles.

FIG. 3A is a perspective view of a foldable rectangular frame of a solar power apparatus included within the solar power system of FIG. 1, wherein the foldable rectangular frame is in its closed position, wherein a first and a second triangular portion are folded together, in accordance with some embodiments.

FIG. 3B is a perspective view of the foldable rectangular frame of FIG. 3A, wherein the foldable rectangular frame is in its open position, in accordance with some embodiments.

FIG. 3C is a side view of the foldable rectangular frame of FIG. 3B, in accordance with some embodiments.

FIG. 4 is a perspective view of the foldable rectangular frame of FIG. 3B with solar rails coupled to the frame, in accordance with some embodiments.

FIG. 5 is a perspective view of the foldable rectangular frame of FIG. 4 with a plurality of solar panels coupled to the solar rails of the frame, in accordance with some embodiments.

FIG. 6A is a side view of an anchor for each of the legs of the frame to be coupled in cement, in accordance with some embodiments.

FIG. 6B is the top view of the anchor of FIG. 6A, in accordance with some embodiments.

FIG. 7 is a side view of a screw anchor for each of the legs of the frame to be coupled in the ground, in accordance with some embodiments.

FIG. 8 is a side view of a flat roof anchor for each of the legs of the frame to be coupled in a roof, in accordance with some embodiments.

### DETAILED DESCRIPTION

The following embodiments describe a detachable solar power apparatus and system. It can be appreciated by one skilled in the art, that the embodiments may be practiced without some or all of these specific details. In other instances, well known process operations have not been described in detail in order not to unnecessarily obscure the embodiments.

In some embodiments, a solar power system is provided. In particular, the detachable solar power system may enable homeowners the ability to uninstall and remove the system from a property and to later re-install it at another property. The solar power system may include one or more solar panels coupled to a folding rectangular frame. The system may further include an inverter coupled to the one or more solar panels to convert DC power into AC power for an alternating current (AC) load. The inverter may include a management control module for detecting when power associated with the DC is above peak power for the AC load. One or more chargeable batteries may couple to the inverter for absorbing the excess power supplied by the solar panels. The system may further include a power interface between the inverter, batteries, and the AC load associated with a house or an electric vehicle.

In some embodiments, the folding rectangular frame may include a first and a second triangular frame portion coupled together. The folding rectangular frame may include a pair of hind legs coupled to the second triangular frame. In some embodiments, the pair of hind legs may comprise a recess in one end thereof, having a retractable ground screw coupled within for securing the folding rectangular frame to the ground or a foundation. For more support, a pair of stabilizing bars may be coupled to the first triangular frame and the second triangular frame. A plurality of solar rails may be coupled to the first triangular frame and the second triangular frame for connecting the one or more solar panels to the folding rectangular frame.

In some embodiments, the folding rectangular frame may include a plurality of end clamps, each respective one of the plurality of end clamps may be coupled to a respective one of the plurality of solar rails for coupling the one or more solar panels to the rectangular frame. Additionally, the folding rectangular frame may include a plurality of mid-clamps coupled between each one or more solar panels for holding each one or more solar panels in place.

Advantageously, homeowners and renters of real estate may safely and reliably harness the power from the sun without damaging the property or its curb appeal. Particularly, the solar power system can be installed on one property and moved to another property when the owners move. The solar panel system design is structurally sound enough to withstand winds of greater than 100 miles per hour. On a clear day, it can supply up to 7000 W of power.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Reference in the description to “one embodiment” or “an embodiment” means that a particular feature, structure, or characteristic described in connection with the embodiment is included in at least one embodiment of the invention. The phrase “in one embodiment” located in various places in this description does not necessarily refer to the same embodiment. Like reference numbers signify like elements throughout the description of the figures.

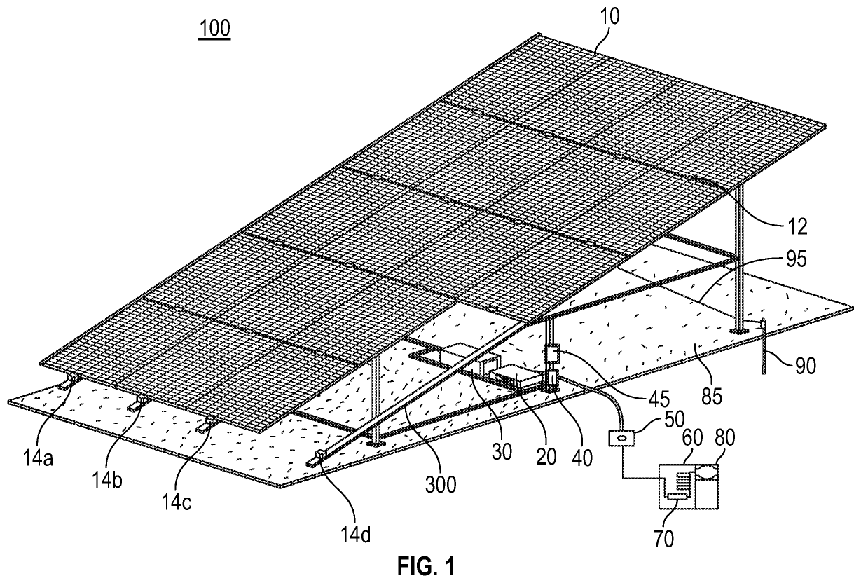

Referring to FIG. 1, perspective view of a solar power system, in accordance with some embodiments is shown. The system 100 includes a folding rectangular frame 300, one or more solar panels 10, an inverter 20, a chargeable battery 30, a reflective plate 85, and a power interface (50, 60,70). In particular, the detachable solar power system 100 may enable homeowners the ability to uninstall and remove the system from one property and to later re-install it at another property. The solar power system 100 may include one or more solar panels 10 coupled to the folding rectangular frame 300. The system may further include the inverter 20 coupled to the one or more solar panels 10 to convert DC power into AC power for an alternating current (AC) load (not shown). The inverter 20 may include a management control module (not shown) for detecting when power associated with the DC is above peak power for the AC load. One or more chargeable batteries 30 may couple to the inverter 20 for absorbing the excess power supplied by the solar panels. The system 100 may further include a power interface (50, 60,70) between the inverter 20, the one or more batteries 30, and the AC load (not shown) associated with a house or an electric vehicle. The AC load may include household lighting and appliances. In the alternative, the AC load may include various makes and models of an electrical vehicle, wherein an output connector (not shown) is adapted to provide, for example, 220V AC to the electric vehicle for power supply.

In some embodiments, the solar panels 10 may couple to frame 300 using end clamps 14a-14d and mid clamps 12. In some embodiments, the solar panel system 100 may include a reflective plate 85, wherein the base of the foldable rectangular frame 300 couples to the reflective plate 85.

In some embodiments, the power interface may include a power inlet box 50 that couples to the inverter 20 having a transfer switch (not shown), wherein the transfer switch is configured to switch a connection between the AC load from an electrical utility power supply to the inverter 20. An electrical panel 60 may couple to the transfer switch of the power inlet box 50. The electrical panel 60 may include a solar back feed breaker 70 that couples to receive the power from the inverter 20. The power interface may include an electric utility meter 80 from the company that supplies the electric utility power supply. In some embodiments, the power interface may include a secure power supply outlet 45 that couples to the inverter 20. In some embodiments, a transformer (not shown) can be coupled between the inverter 20 and the secure power supply outlet 45. This outlet 45 can grant access to the power supply day and night. The outlet 45 may possess one or more outlets for plug-in, powering up to 2,000 watts for household appliances, such as refrigerator and other equipment in the event of a power outage on the grid.

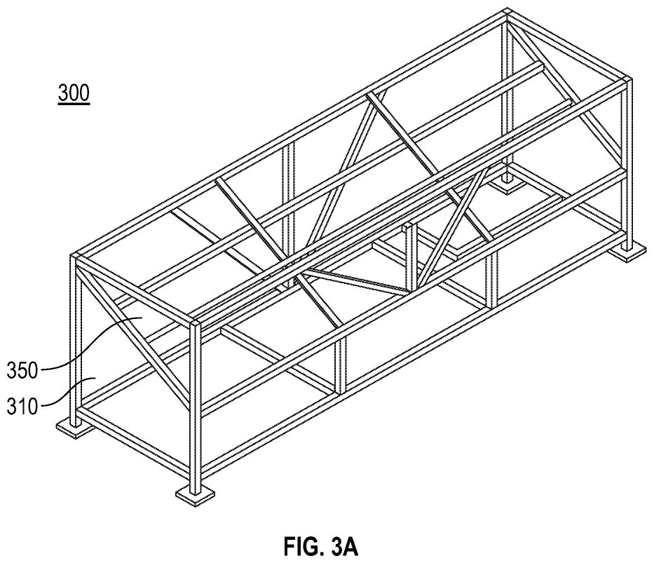

In some embodiments, the power interface (50,60,70) may include a safety switch disconnect (AC disconnect) 40 coupled between the inverter 20 and the power inlet box 50 to enable manual disconnect of the power supplied to the AC load. In the alternative, the safety switch disconnect 40 can enable an automatic disconnection of the power supplied to the AC load, when the power exceeds a predetermined threshold. For the purpose of grounding the system 100, the power interface (50,60,70) may also include one or more ground rods 90 coupled to a respective on of the pair of hind legs (352a, 352b) of the frame 300 (to be discussed in detail with respect to FIGS. 3B and 3C). A ground clamp underwire 95 may be coupled to the one or more ground rods 90.

The management control module of the inverter 20 can be implemented as hardware, firmware, or a processor executing software, or combinations thereof. It should be appreciated that, where a software-based embodiment is disclosed herein, the software can be embodied in a physical machine such as a controller. For example, a controller could include a first module and a second module. A controller could be configured to perform various actions, e.g., of a method, an application, a layer or an agent.

The embodiments of the management control module of the inverter 20 can also be embodied as computer readable code on a non-transitory computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, flash memory devices, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

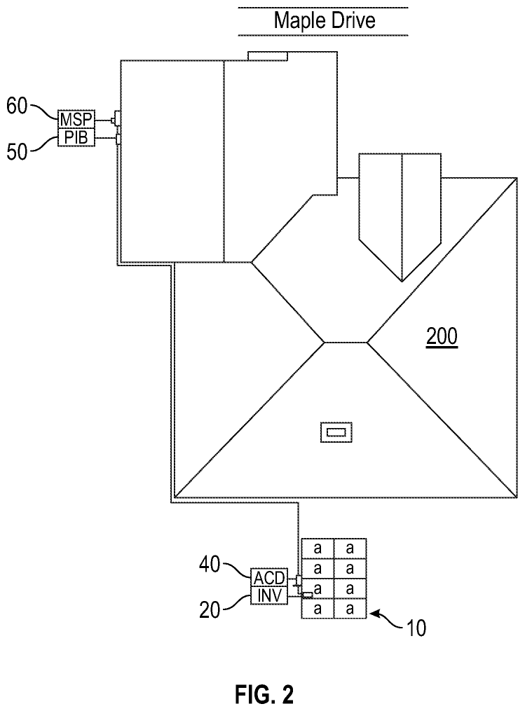

During installation, the one or more solar panels 10 may be coupled to the foldable rectangular frame 300 in its open position (to be described further in detail with reference to FIGS. 3A-5). For example, referring to FIG. 2, a block diagram of the solar power system of FIG. 1 as installed at a house 200 to provide power for various AC loads, such as lights, household appliances, and the like, is shown. In operation, the solar panels 10 are configured to absorb the radiation from the sun and convert the same into Direct Current (DC). The inverter 20 may be coupled to the one or more solar panels 10 to receive the DC power and convert this power into AC power. When the management control module (not shown) within inverter 20 detects that the power associated with the DC is above peak power for the AC load, the inverter 20 switches the power supplied by the solar panels 10 to be supplied to the one or more chargeable batteries 30 to absorb the excess power supplied by the solar panels 10. Otherwise, the power supplied by the inverter 20 is sent to the power inlet box 50, which couples to the main service panel 60. The main service panel 60 can supply the AC power to the AC load (not shown) associated with the house 200 or an electric vehicle (not shown). In some embodiments, access to the electric power can be accessed within the garage, wherein an output connector (not shown) within the garage can couple to the main service panel 60. In other embodiments, the output connector (not shown) associated with supplying power to an electric vehicle may be mounted on the exterior of the house 200.

Referring to FIG. 3A, a perspective view of a foldable rectangular frame 300 of a solar power apparatus included within the solar power system 100 of FIG. 1, wherein the foldable rectangular frame 300 is in its closed position, wherein a first and a second triangular portion (310, 35) are folded together, in accordance with some embodiments, is shown. The foldable rectangular frame 300 can be made from various materials including metal, plastic, iron, stainless steel, and the like. In particular, the first triangular frame 310 may be coupled to the second triangular 350 by one or more coupling members. In some embodiments, the coupling members may be selected from a group including hinges, brackets, braces, pivoting members, and the like.

The foldable rectangular frame 300 may also include a pair of hind legs coupled to the second triangular frame 350. In particular, referring to FIG. 3B, a perspective view of the foldable rectangular frame of FIG. 3A, wherein the foldable rectangular frame 300 is in its open position, in accordance with some embodiments, is shown. As displayed, a pair of hind legs (352a, 352b) may couple to the second triangular frame 350 of frame 300. In some embodiments, the pair of hind legs (352a, 352b) may include a recess (not shown) in one end thereof and a retractable ground screw (not shown) coupled within the recess for securing the folding rectangular frame in the ground. For additional support, the foldable rectangular frame 300 may include a pair of stabilizing bars (354a, 354b) coupled to the first triangular frame 310 and the second triangular frame 350.

Further, the foldable rectangular frame 300 may include a plurality of solar rails coupled to the first triangular frame 310 and the second triangular frame 350 for connecting the one or more solar panels 10 to the folding rectangular frame 300. In particular, referring to FIG. 3C, a side view of the foldable rectangular frame of FIG. 3B, in accordance with some embodiments, is shown. The plurality of solar rails (330a-330f) may be coupled to the first triangular frame 310 and the second triangular frame 350 for connecting the one or more solar panels 10 to the folding rectangular frame 300.

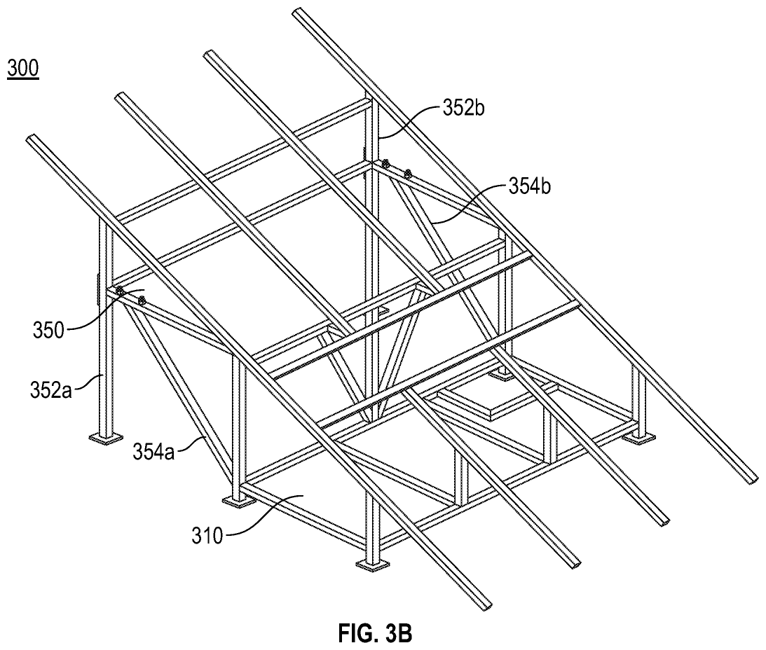

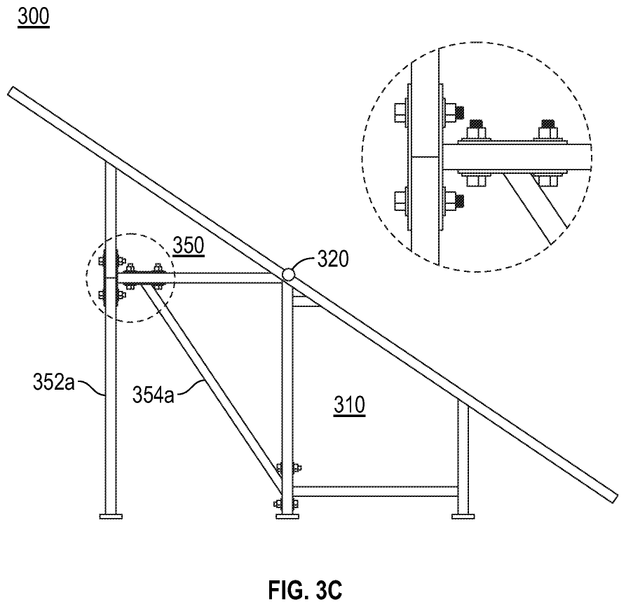

Referring to FIG. 4, a perspective view of the foldable rectangular frame of FIG. 3B with solar rails coupled to the frame, in accordance with some embodiments, is shown. During installation, the solar rails (330a-330f) couple to the frame 300. In another action, the one or more solar panels 10 are coupled to the rails (330a-330f) installed on the frame 300. In particular, referring to FIG. 5, a perspective view of the foldable rectangular frame of FIG. 4 with a plurality of solar panels coupled to the solar rails of the frame, in accordance with some embodiments, is shown. As displayed in FIGS. 1, 4, and 5, a plurality of end clamps (14a-d) may be coupled to a respective one of the plurality of solar rails (330a-330d) for coupling the one or more solar panels 10 to the rectangular frame 300. Further, a plurality of mid-clamps 12 may be coupled between each one or more solar panels 10 for stabilizing each one or more of the solar panels in place.

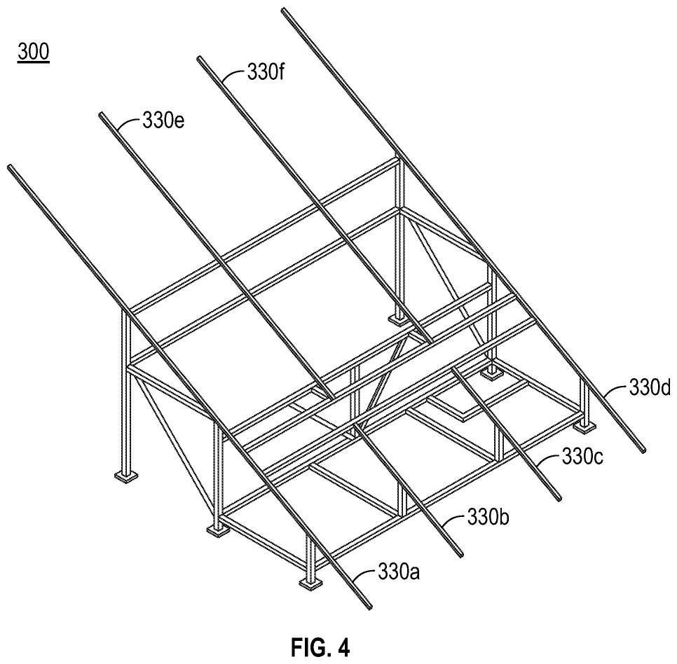

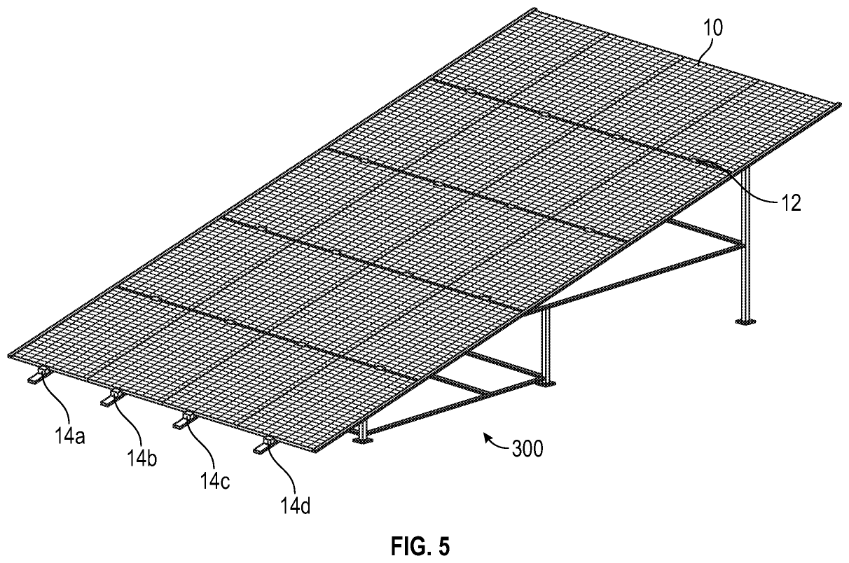

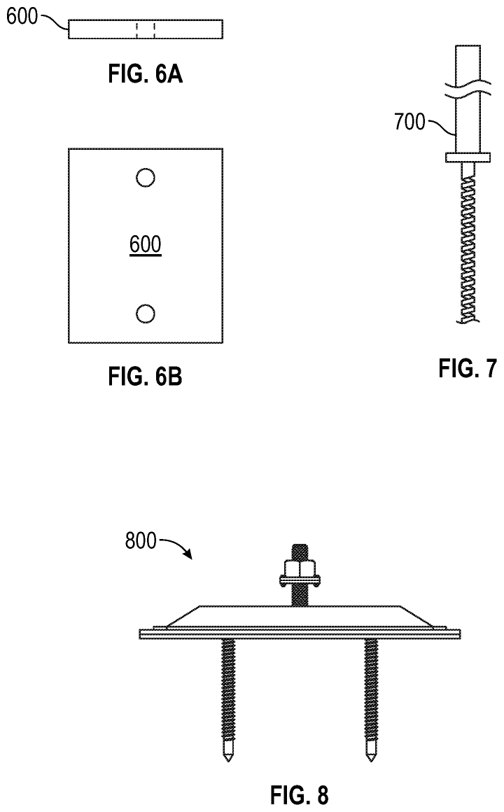

In some embodiments, the frame 300 can be further stabilized using a mounting anchor 600 for a cement foundation as is shown in FIG. 6A. Referring to FIG. 6A, a side view of an anchor for each of the legs of the frame to be coupled in cement, in accordance with some embodiments, is shown. FIG. 6B illustrates the top view of the anchor 600 of FIG. 6A, in accordance with some embodiments. In the alternative, frame 300 can be coupled to ground using the mounting screw anchor 700 of FIG. 7. Particularly, FIG. 7 shows a side view of the mounting screw anchor 700 for each of the legs of the frame 300 to be coupled in the ground, in accordance with some embodiments. In other embodiments, frame 300 may be coupled to the roof of a house using the mounting anchor set 800 of FIG. 8. Particularly, FIG. 8 displays a side view of a flat roof anchor for each of the legs of the frame to be coupled in a roof, in accordance with some embodiments. All three types of anchors including the mounting anchor plate 600, the mounting screw anchor 700 and the flat roof anchor 800 can be made from various materials including metal, plastic, iron, stainless steel, and the like.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention. It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “I” symbol includes any and all combinations of one or more of the associated listed items. As used herein, the singular forms “a”, “an” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved. With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” perform a task or tasks. In such contexts, the phrase “configured to” is used to so connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware; for example, circuits, memory storing program instructions executable to implement the operation, etc. Reciting that a unit/circuit/component is “configured to” perform one or more tasks is expressly intended not to invoke 35 U.S.C. 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A solar power system comprising:
a folding rectangular frame;
one or more solar panels coupled to the folding rectangular frame, wherein each one of the one or more solar panels configured to generate direct current (DC) from solar radiation;
an inverter coupled to the one or more solar panels to convert DC power into AC power for an alternating current (AC) load, wherein the inverter having a management control module for detecting when power associated with the DC is above peak power for the AC load;
a chargeable battery coupled to the inverter; wherein when the management control module detects power above the peak power, the inverter directs excess power above the peak power to charge the chargeable battery; and
a power interface coupled to the inverter and the chargeable battery, wherein the power interface coupled to an electrical panel associated with the AC load for transmitting the AC power to the AC load from the inverter and the chargeable battery.

2. The solar power system of claim 1, wherein the folding rectangular frame comprises:
a first triangular frame;
a second triangular frame coupled to the first triangular frame;
a pair of hind legs coupled to the second triangular frame;
a pair of stabilizing bars coupled to the first triangular frame and the second triangular frame; and
a plurality of solar rails coupled to the first triangular frame and the second triangular frame for connecting the one or more solar panels to the folding rectangular frame.

3. The solar power system of claim 2, wherein each one of the pair of hind legs comprises:
a recess in one end thereof; and
a retractable ground screw coupled within the recess for securing the folding rectangular frame in the ground.

4. The solar power system of claim 2, wherein the folding rectangular frame further comprises:
a plurality of end clamps, each respective one of the plurality of end clamps coupled to a respective one of the plurality of solar rails for coupling the one or more solar panels to the rectangular frame; and
a plurality of mid-clamps coupled between each one or more solar panels for stabilizing each one or more solar panels in place.

5. The solar power system of claim 1, wherein the power interface comprises:
a power inlet box, coupled to the inverter having a transfer switch, wherein the transfer switch is configured to switch a connection between the AC load from an electrical utility power supply to the inverter; and
an electrical panel coupled to the transfer switch, the electrical panel having a solar back feed breaker that couples to receive the power from the inverter.

6. The solar power system of claim 1, wherein the power interface further comprises:
an safety switch (AC) disconnect coupled to the inverter for disconnecting the inverter when the power surpasses a predetermined limit and for manually disconnecting the AC power form the AC load;
one or more ground rods coupled to a respective on of the pair of hind legs; and
a ground clamp underwire coupled to the one or more ground rods.

7. The solar power system of claim 5, further comprising:
a safety switch disconnect coupled between the inverter and the power inlet box to enable manual disconnect of the power supplied to the AC load.

8. The solar power system of claim 5, wherein the power interface further comprises:
an output connector couple to receive the power from the inverter, wherein the output connector is adapted to provide 220V AC to an electric car for power supply.

9. A solar power apparatus comprising:
a folding rectangular frame;
one or more solar panels coupled to the folding rectangular frame, wherein each one of the one or more solar panels configured to generate direct current (DC) from solar radiation;
an inverter coupled to the one or more solar panels to convert DC power into AC power for an alternating current (AC) load, wherein the inverter having a management control module for detecting when power associated with the DC is above peak power for the AC load; and
one or more chargeable batteries coupled to the inverter; wherein when the management control module detects power above the peak power, the inverter directs excess power above the peak power to charge the chargeable battery.

10. The solar power apparatus of claim 9, wherein the folding rectangular frame comprising:
a first triangular frame;
a second triangular frame coupled to the first triangular frame;
a pair of hind legs coupled to the second triangular frame;
a pair of stabilizing bars coupled to the first triangular frame and the second triangular frame; and
a plurality of solar rails coupled to the first triangular frame and the second triangular frame for connecting the one or more solar panels to the folding rectangular frame.

11. The solar power system of claim 10, wherein each one of the pair of hind legs comprises:
a recess in one end thereof; and
a retractable ground screw coupled within the recess for securing the folding rectangular frame in the ground.

12. The solar power apparatus of claim 10, wherein the folding rectangular frame further comprising:
a plurality of end clamps, each respective one of the plurality of end clamps coupled to a respective one of the plurality of solar rails for coupling the one or more solar panels to the rectangular frame; and
a plurality of mid-clamps coupled between each one or more solar panels for holding each one or more solar panels in place.
